(19) United States
(12) Patent Application Publication
(10) Pub. No.: US 2024/0332679 A1
(43) Pub. Date: Oct. 3, 2024

(54) High-Strength Battery Cell Housing for Large-Format Round Battery Cells, Consisting of an Aluminium Alloy

(71) Applicants: Martin Christoph Lentz, Bonn (DE); Mathis Ruppert, Bonn (DE)

(72) Inventors: Martin Christoph Lentz, Bonn (DE); Mathis Ruppert, Bonn (DE)

(73) Assignee: Speira GmbH, Grevenbroich (DE)

(21) Appl. No.: 18/742,512

(22) Filed: Jun. 13, 2024

Related U.S. Application Data
(63) Continuation of application No. PCT/EP2022/086044, filed on Dec. 15, 2022.

(30) Foreign Application Priority Data
Dec. 17, 2021 (EP) 21215667.3

(51) Int. Cl. H01M 50/119; H01M 50/107; H01M 50/133; H01M 50/134; H01M 50/152

(52) U.S. Cl. CPC H01M 50/119; H01M 50/107; H01M 50/133; H01M 50/134; H01M 50/152

(57) ABSTRACT

A battery cell housing of a round battery cell includes a cylindrical housing shell with an outer diameter of more than 15 mm, preferably more than 20 mm, particularly preferably more than 22 mm, and to the use of an aluminium alloy for manufacturing a battery cell housing. The object of providing a high-strength battery cell housing of a round battery cell, having a cylindrical housing shell with a diameter of more than 15 mm, preferably more than 20 mm, in particular more than 22 mm, which allows improved properties regarding heat management and weight of the round battery cell without excessively limiting the capacity of the round battery cell, is achieved in that the housing shell consists at least partially of an aluminium alloy, and the yield strength R_{p0.2} of the housing shell is at least 183 MPa, preferably at least 220 MPa, particularly preferably at least 250 MPa.

### CROSS-REFERENCE TO RELATED PATENT APPLICATIONS

This patent application is a continuation of International Application No. PCT/EP2022/086044, filed on Dec. 15, 2022, which claims the benefit of priority to European Patent Application No. 21215667.3, filed Dec. 17, 2021, the entire teachings and disclosures of both applications are incorporated herein by reference thereto.

### FIELD OF THE INVENTION

The invention relates to a battery cell housing of a round battery cell, comprising a cylindrical housing shell with an outer diameter of more than 15 mm, preferably more than 20 mm, particularly preferably more than 22 mm, and to the use of an aluminium alloy for manufacturing a battery cell housing according to the invention.

### BACKGROUND OF THE INVENTION

Battery cells are used in a wide variety of technical applications to supply an electrical load with electrical energy. Application fields for battery cells are, for example, in electromobility, particularly in electric cars, electric bicycles and electric scooters, in consumer electronics, particularly in laptop computers, tablet computers, mobile phones, digital cameras and video cameras, or in energy technology, particularly in battery storage, to name just a few. A plurality of battery cells are often connected together in series or parallel to form a battery module, or a battery system. However, there are also applications in which individual battery cells are used as an energy source.

Battery cells may essentially be differentiated into primary cells, which can only be discharged once and cannot be recharged, and secondary cells, which are rechargeable. The necessary electrochemical processes that provide the functionality of the battery cell may be implemented with a wide variety of different materials in both primary and secondary cells. Examples of primary cells in this context are alkali-manganese cells, zinc-carbon cells, nickel oxyhydroxide cells or lithium/iron sulphide cells, to name just a few. Examples of secondary cells are lithium ion cells, sodium ion cells, nickel-cadmium cells, nickel/metal hydride cells or nickel-zinc cells, to name just a few.

For a number of years, lithium ion secondary cells have increasingly been used particularly in the fields of electromobility and consumer electronics, among other things because of their comparatively high gravimetric and volumetric energy densities. Like other types of battery cells, lithium ion secondary cells have a battery cell housing. This forms the outer shape of the battery cell and encloses a cavity, which contains among other things the anode material, the cathode material, the separators and an electrolyte. A distinction may be made between various designs of a battery cell housing: cylindrical battery cell housings essentially have the shape of a cylinder. If the height of the cylinder is greater than the diameter, they are referred to as round cells, otherwise as button cells. Battery cell housings of prismatic design essentially have the shape of a prism, in particular a cuboid. Another variant is the pouch design, in which the battery cell housing essentially has the shape of a pocket or pouch.

For example, from the Japanese patent application JP 2016 113627 A it is known to use an aluminium alloy for providing a prismatic batter cell housing. However, a cylindrical battery cell having a shell housing made of an aluminium alloy are not known from the Japanese patent application.

Owing to high requirements for strength and mechanical stability as well as high requirements for electrochemical stability in relation to the electrolyte acting corrosively on the battery cell housing, cylindrical battery cell housings in particular have to date generally been manufactured from nickel-plated steel. The dominant round battery cell format is round battery cells of the type 18650 with a diameter of 18 mm. In various applications, these are being replaced with 21 mm round battery cells of the type 21700. Moreover, substitution of round battery cells of the type 46800 with a diameter of 46 mm for round battery cells of the type 21700 is already to be expected, for example in the field of electromobility. The increasing cell formats are placing greater demands on the removal of the heat generated inside the round battery cell and therefore on the electrical and thermal conductivities of the battery cell housing.

Battery packs with a large number of round battery cells also require contributions from the round battery cells to the mechanical design of the battery packs in order to achieve weight savings.

Approaches with the use of aluminium alloys for cylindrical battery cell housings are already known, but are limited to the aluminium alloy AA3003. For example, a battery cell housing with an outer diameter of 13.8 mm and a height of 49.0 mm is known from the US patent specification U.S. Pat. No. 6,258,480 B1. The battery cell housing was manufactured by deep drawing and stretch drawing from a round segment of an aluminium alloy sheet consisting of an aluminium alloy of the type AA3003.

Whereas in the case of battery cell housings with smaller cross sections, the mechanical stability of the battery cell housing results essentially from the stiffness of the geometric shape as a cylinder, the yield strength R_{p0.2} of the material of the battery cell housing plays an increasing role in the case of larger cross sections of the round battery cells beyond an outer diameter of 15 mm. In terms of mechanical strength, nickel-plated steel, which is known per se as a material for battery cell housings, is to be regarded here as a reference. A typical yield strength R_{p0.2} of 350 MPa is assumed for nickel-plated steel strips of the type AISI 1020.

The reference material steel still offers the smallest wall thicknesses in the increasing cell formats and therefore the greatest possible volumes for accommodating the electrode winding, or the so-called “jelly roll”. This “jelly roll” consists of a multi-layer arrangement of anode material, separator layer and cathode material, which is wound on a winding core and is arranged in the battery cell housing. It determines the energy capacity of the round battery cell.

Battery cell formats with diameters of more than 15 mm are pacing increasingly higher demands on the removal of heat generated inside the battery cell housings. Steel does not offer an optimal solution here. In addition, there are also disadvantages when used in electromobility due to the weight of round battery cells consisting of steel. However, weight is an important factor for the implementation of battery-powered electric drives in electromobility.

### SUMMARY OF THE INVENTION

On the basis of this, it is an object of the present invention to provide a high-strength battery cell housing of a round battery cell having a cylindrical housing shell with a diameter of more than 15 mm, preferably more than 20 mm, in particular more than 22 mm, which allows improved properties with regard to heat management and weight of the round battery cell without thereby excessively limiting the capacity of the round battery cell. Further, a use of an aluminium alloy for manufacturing a battery cell housing is intended to be provided.

The aforementioned object is achieved for a battery cell housing with the features of claim 1.

According to the invention the housing shell consists at least partially of an aluminium alloy and wherein the yield strength R_{p0.2} of the housing shell is at least 183 MPa, preferably at least 220 MPa, particularly preferably at least 250 MPa.

According to the invention, a housing shell consisting at least partially of an aluminium alloy means a housing shell which consists of an aluminium alloy and, for example, may have further features, for example an outer or inner coating, although these are not crucial for the mechanical strength of the housing shell.

Studies have shown that a housing shell of a round battery cell, which consists at least partially of an aluminium alloy and has a yield strength R_{p0.2} of at least 183 MPa, in the case of large-format round battery cells, for example of the format 4680 with a diameter of 46 mm, may be provided with a wall thickness which, when specifying a typical internal pressure stability of 9 MPa to be satisfied, allows a winding length of the “jelly roll” of the round battery cell that is only less than 5% less in comparison with the housing shell consisting of steel of the type AISI 1020. In the studies, a winding core diameter of 4 mm was assumed.

At the same time, the significantly higher electrical and thermal conductivities of the aluminium alloy of the housing shell compared to steel ensure significantly improved dissipation of heat overall from the interior of the round battery cell. With higher yield strengths of the housing shell, for example 258 MPa, the winding length losses of the aforementioned “jelly roll” are even reduced to less than 2%. Further, due to the significantly higher density of steel, there are significant weight advantages for the round battery cell housing consisting of an aluminium alloy. These are, in fact, considerable and may be up to a factor of nearly 2 for a housing shell with, for example, a yield strength R_{p0.2} of 258 MPa.

According to a first configuration of the battery cell housing, the housing shell of the battery cell housing has a wall thickness which satisfies the following relationship: external diameter of the round battery cell/wall thickness >41.5, preferably >47.5, particularly preferably >55.0. The greater the ratio of the outer diameter of the housing shell and the wall thickness are, the smaller the loss of volume inside the housing shell is for the winding length of the “jelly roll”, which is proportional to the capacity of the battery cell, and the weight of the battery cell housing is also commensurately less. Consequently, the gravimetric energy density may be significantly improved by reducing wall thickness in conjunction with the low density of aluminium.

The electrical conductivity of aluminium alloys is significantly higher than that of steel, and is 23 MS/m even for AA3003 aluminium alloys. According to a further configuration, the housing shell preferably has an electrical conductivity of more than 25 MS/m, preferably more than 28 MS/m, particularly preferably more than 30 MS/m. The electrical conductivities are of course dependent on the alloy composition of the aluminium alloy, and also on the microstructural state. Low-alloy AlMgSi alloys, which are hardenable and may be converted to one of the states T6, T6x, T7 or T7x by solution annealing and subsequent artificial ageing, have a combination of particularly high electrical conductivities and very high strengths. Steel of the type AISI 1020, on the other hand, has an electrical conductivity of about 6.3 MS/m, which is more than a factor of 4 lower than the highest electrical conductivities of aluminium alloys. It is expected that the performance of secondary batteries with a battery cell housing according to the invention will be improved when charging and discharging the battery, since the ohmic resistance of the cell is reduced and the thermal conduction in the cell housing is improved.

According to the invention, the aluminium alloy of the housing shell of the battery cell housing has the following composition in wt %:
0.2%≤Si≤2.0%, preferably 0.2%≤Si≤1.5% or 0.2%≤Si≤1.3%,
Fe≤0.5%,
Cu≤0.8%, preferably ≤0.6%, more preferably ≤0.45%
Mn≤1.4%, preferably 1.0%≤Mn≤1.4%, more preferably Mn≤0.6%,
Mg≤2.0%, preferably ≤1.5%, more preferably 0.2%≤Mg≤1.5%
Cr≤0.25%, preferably ≤0.15%,
Zn≤0.4%, preferably ≤0.25%,
Ti≤0.2%, preferably 0.01%≤Ti≤0.20%,
V≤0.05%, preferably ≤0.03%, more preferably ≤0.0015%,
Zr≤0.25%, preferably ≤0.20, more preferably ≤0.05% or ≤0.0015%,
Ni≤0.2%, preferably ≤0.05%, more preferably ≤0.03% or ≤0.0015%,
the remainder being Al with unavoidable impurities, individually at most 0.05% and in total at most 0.15%.

In combination with the iron and manganese contents in the amounts specified, the silicon content of 0.2 wt %≤Si≤2.0 wt % leads in particular to relatively uniformly distributed, compact particles of the quaternary α-Al(Fe,Mn)Si phase. These precipitated particles increase both the strength of the aluminium alloy and its electrical and thermal conductivities, since they remove iron and manganese from the solid solution without detrimentally affecting other properties such as corrosion behaviour, i.e. electrolyte stability, or formability. Silicon contents of less than 0.2 wt % lead to reduced precipitation of α-Al(Fe,Mn)Si phases, which may impair the electrical and thermal conductivities because of dissolved manganese. Furthermore, the absence of α-Al(Fe,Mn)Si phases has a detrimental effect on the tool wear. Silicon contents in combination with magnesium may lead to the formation of Mg₂Si phases or metastable phases of the β precipitation sequence. Silicon contents of more than 0.3 wt %, in combination with magnesium, may generate a sufficiently large phase fraction so that a significant increase in strength may be achieved by precipitation hardening. If the silicon content is too high, the solubility limit of Mg₂Si will be exceeded, so that no additional contribution is made to the strength by precipitation hardening. Furthermore, the likelihood increases of forming coarse Mg₂Si phases which cannot be redissolved during solution annealing in technically relevant periods of time and may impair further precipitation hardening as well as formability. The silicon content is therefore limited to 0.2 wt %≤Si≤2 wt %. In preferred variants of the aluminium alloy, the silicon content is limited to 0.2 wt %≤Si≤1.5 wt %, particularly preferably to 0.3 wt %≤Si ≤1.3 wt %, in order to allow an ideal strength and rapid precipitation hardening.

The iron content of the aluminium alloy is at most 0.5 wt %. Iron in combination with the manganese content according to the invention in the amount specified leads to the formation of Al₆(Mn,Fe) phases, and as already explained above, in combination with the silicon and manganese contents according to the invention in the amounts specified, to the precipitation of particles of the quaternary α-Al(Fe,Mn)Si phase. Iron in this case contributes to lowering the solubility of manganese in aluminium, so that more manganese is bound in intermetallic phases, which has a positive effect on the electrical and thermal conductivities. In addition, the intermetallic phases influence recovery and recrystallisation processes and improve the thermal stability of the mechanical properties. The interaction with silicon in α-Al(Fe,Mn)Si or AlFeSi phases removes silicon from the solid solution, which may impair the precipitation hardening. Above 0.5 wt %, iron may promote the formation of coarse intermetallic phases. The use of recycled aluminium products, which generally involves the addition of iron, is furthermore desirable. The aluminium alloy is therefore preferably not iron-free, i.e. the iron content is greater than 0 wt %.

The copper content of the aluminium alloy is in the range Cu≤0.8 wt %. In one embodiment of the aluminium alloy, the copper content of the aluminium alloy is in the range Cu≤0.45 wt %, preferably 0.1 wt %≤Cu≤0.2 wt %. The fact that a copper content of up to 0.8 wt % is permitted results in an increased tolerance of the aluminium alloy for copper-containing aluminium alloy scrap, which promotes the achievement of high proportions of recycled material in the manufacture of the battery housing. Overall, copper contributes to increasing strengths. Since excessively high copper contents may have a detrimental effect on the corrosion properties, however, the copper content is limited to at most 0.6 wt %, preferably at most 0.45 wt %, in order to achieve an improved electrolyte stability.

The manganese content of the aluminium alloy is at most 1.4 wt %. In addition to a high corrosion resistance, high manganese contents of from 1.0 wt % to 1.4 wt % also offer high strengths in a highly cold-hardened state, e.g. H18 or H19, in combination with the silicon and iron contents in the amounts specified for the precipitation of particles of the quaternary α-Al(Fe,Mn)Si phase as well as the Al₆(Mn,Fe) phase. The intermetallic phases hinder recovery and recrystallisation processes and therefore improve the thermal stability of the mechanical properties. Manganese contents of more than 1.4 wt % promote the formation of coarse intermetallic phases, which have an unfavourable effect on the forming properties in the deep drawing process. Furthermore, manganese contents of more than 1.4 wt % reduce the electrical and thermal conductivities of the battery cell housing so greatly that the thermal management becomes inefficient. Manganese contents of at most 0.6 wt % reduce the increase in strength by dispersoid and solid solution hardening. Since more silicon is available for precipitation hardening due to the lower manganese content, an increase in strength by precipitation hardening may be achieved in combination with magnesium contents of from 0.2 wt % to 1.5 wt %. This material combination has achieved the highest yield strength values in the present studies.

The magnesium content of the aluminium alloy is at most 2.0 wt %. In one embodiment of the battery cell housing, the magnesium content is at most 1.5 wt %, preferably 0.2 wt %≤Mg≤1.5 wt %. The fact that a magnesium content of up to 2.0 wt % is permitted results in an increased tolerance of the aluminium alloy for magnesium-containing aluminium alloy scrap such as UBC scrap, which further promotes the achievement of high proportions of recycled material in the manufacture of the battery cell housings. In addition, the presence of magnesium above a content of at least 0.5 wt % leads to efficient solid solution hardening, which contributes to increased cold hardening and therefore increases the strength. In combination with silicon, with suitable solution annealing and artificial ageing, magnesium forms metastable precipitates of the β precipitation sequence, which significantly increase the strength by precipitation hardening. Since excessively high magnesium contents have a detrimental effect on the electrical and thermal conductivities, however, the magnesium content is limited according to the invention to at most 2.0 wt %, preferably 1.5 wt %. In order to achieve improved mechanical properties, the magnesium content in one embodiment is set to a range of 0.2 wt %≤Mg≤1.5 wt %. This represents a compromise between high strength, good forming behaviour and high electrical and thermal conductivities, together with good recycling tolerance.

The chromium content of the aluminium alloy is in the range Cr≤0.25 wt %. In one embodiment of the battery cell housing according to the invention, the chromium content of the aluminium alloy is in the range Cr≤0.15 wt %, preferably Cr≤0.03 wt %. The fact that a chromium content of up to 0.25 wt % is permitted results in an increased tolerance of the aluminium alloy for chromium-containing aluminium alloy scrap, which promotes the achievement of high proportions of recycled material in the manufacture of the battery cell housings. In addition, chromium also has a strength-increasing effect and forms dispersoids, which increase the thermal stability and hinder softening due to recrystallisation or recovery. Since excessively high chromium contents may have a detrimental effect on the electrical conductivity of the aluminium alloy, however, the chromium content is limited to 0.15 wt %, preferably at most 0.03 wt %, with a recycling tolerance and strength that are still sufficient.

The zinc content of the aluminium alloy is in the range Zn≤0.4 wt %. In one embodiment of the battery cell housing, the chromium content of the aluminium alloy is at most 0.25 wt %, preferably at most 0.1 wt %.

The fact that a zinc content of up to 0.4 wt % is permitted results in an increased tolerance of the aluminium alloy for zinc-containing aluminium alloy scrap, which further promotes the achievement of high recycling rates. Zinc also has a strength-increasing effect. Since excessively high zinc contents reduce the weldability, the electrical and thermal conductivities as well as the corrosion resistance of the aluminium alloy, however, the zinc content is limited to at most 0.4 wt %. Improved weldability and good electrolyte stability with a simultaneous contribution by zinc to the strength increase is achieved by a zinc content of at most 0.25 wt %, preferably at most 0.1 wt %.

The titanium content of the aluminium alloy is at most 0.2 wt %. In one embodiment of the battery cell housing, the titanium content of the aluminium alloy is in the range 0.01 wt %≤Ti≤0.20 wt %, preferably 0.005 wt %≤Ti≤0.05 wt %. The fact that a titanium content of up to 0.20 wt % is permitted results in an increased tolerance of the aluminium alloy for titanium-containing aluminium alloy scrap, which promotes the achievement of high proportions of recycled material in the manufacture of battery cell housings. Titanium is used in small amounts for grain refining when casting the aluminium alloy. Excessively high titanium contents may detrimentally affect the forming properties of the aluminium alloy and significantly reduce the electrical and thermal conductivities, however, so that the titanium content is limited according to the invention to at most 0.2 wt %. Preferably, the titanium content is 0.01 wt %≤Ti≤0.20 wt %.

Vanadium is used in aluminium alloys to control recrystallization and grain refining. Since vanadium greatly impairs the electrical and thermal conductivities of aluminium both as an intermetallic phase and when dissolved, the vanadium content of the aluminium alloy is limited to at most 0.05 wt. %, preferably at most 0.03 wt. %, particularly preferably at most 0.0015 wt. %. Higher vanadium contents impair the conductivity to a degree that conflicts with the desired increase in thermal management efficiency. Zirconium is also used in aluminium alloys to control recrystallization and grain refining. The solubility of zirconium in aluminium is limited, however, so that excessively high zirconium contents cause the formation of coarse intermetallic phases that may impair the formability. Since zirconium furthermore impairs the electrical and thermal conductivities of aluminium, the zirconium content of the aluminium alloy is limited to at most 0.25 wt %, preferably at most 0.2 wt %, preferably at most 0.05 wt %, particularly preferably at most 0.0015 wt %. Higher zirconium contents impair the conductivity to a degree that conflicts with the desired increase in thermal management efficiency.

Nickel is used in aluminium alloys to increase thermal stability. However, nickel impairs the corrosion resistance of aluminium alloys and has limited availability. The nickel content of the aluminium alloy is therefore limited to at most 0.2 wt %, preferably at most 0.05 wt %, particularly preferably at most 0.03 wt %.

According to a further, particularly conductive configuration of the battery cell housing, the aluminium alloy of the housing shell is hardenable and has the following composition in wt %:
0.3%≤Si≤0.7%,
Fe≤0.5%,
Cu≤0.45%,
Mn≤0.10%, preferably ≤0.05%,
0.22%≤Mg≤0.8%,
Cr≤0.03%,
Zn≤0.1%,
0.01%≤Ti≤0.2%,
V≤0.03%, preferably ≤0.015%,
Zr≤0.05%, preferably ≤0.015%,
Ni≤0.03%, preferably ≤0.015%,
the remainder being Al with unavoidable impurities, individually at most 0.03% and in total at most 0.10%.

In this aluminium alloy, the magnesium content at 0.22 wt. % to 0.8 wt. % is precisely matched to the silicon content from 0.3 wt. % to 0.7 wt. %, so that the aluminium alloy allows effective precipitation hardening by metastable precipitations of the β precipitation sequence and thereby achieves high yield strengths R_{p0.2} of more than 183 MPa in the temper state T6 or T6x, for example. The iron content is at most 0.5 wt. % and substantially contributes to the thermal stability of the mechanical properties of the housing shell. The aluminium alloy of this configuration has a manganese content of only at most 0.10 wt. %, preferably at most 0.05 wt. %, and may therefore be regarded as almost manganese-free. In this way, less quaternary α-Al(Fe,Mn)Si phases may be formed and more silicon may be available for precipitation hardening. Furthermore, the detrimental effect of manganese on the electrical and thermal conductivities is limited. Because of the low alloy state, not only very high yield strengths in the temper state T6 or T6x, but also particularly high values of the electrical conductivity are achieved. With regard to the influences of the contents of chromium, zinc, titanium, vanadium, zirconium and nickel in this configuration, reference is made to the technical effects described above, which also occur in this configuration of the aluminium alloy.

Finally, the aluminium alloy of the housing shell according to a further configuration of the battery cell housing is not hardenable or naturally hard, and has the following composition in wt %:
0.2%≤Si≤0.6%,
Fe≤0.5%,
Cu≤0.45%, 1.0%≤Mn≤1.4%,
Mg≤1.10%, preferably ≤0.8%,
Cr≤0.25%,
Zn≤0.4%, Ti≤0.2%, preferably 0.01%≤Ti≤0.2%,
V≤0.05%,
Zr≤0.25%,
Ni≤0.2%,
the remainder being Al with unavoidable impurities, individually at most 0.05% and in total at most 0.15%.

In this configuration of the aluminium alloy, the manganese content of from 1.0 wt. % to at most 1.4 wt. % in combination with the silicon and iron contents in the amounts specified contributes to the precipitation of particles of the quaternary α-Al(Fe,Mn)Si phase as well as the Al₆(Mn,Fe) phase. The intermetallic phases hinder recovery and recrystallisation processes and therefore improve the thermal stability of the mechanical properties. In this configuration of the aluminium alloy, high values of the yield strength R_{p0.2} of 183 MPa may even be achieved with high to very high cold hardening (H18 or H19 state) by dispersoid and solid solution hardening.

According to a further configuration of the battery cell housing, in the case of a hardenable embodiment of the aluminium alloy, the housing shell has the temper state T6 or T6x. This temper state provides very high values of the yield strength R_{p0.2} for hardenable aluminium alloys by precipitation hardening. The advantages of a battery cell housing consisting of an aluminium alloy in terms of weight, electrical conductivity and thermal conductivity of the battery cell housing are particularly high in comparison with a battery cell housing consisting of steel.

If the housing shell according to a next configuration has at least one lid, which is connected to the housing shell by a force fit and/or materially, a cup may for example be provided for receiving the “jelly roll” of a round battery cell, the lid then providing the bottom of the cup. The lid may be manufactured by deep drawing and/or stretch drawing a cup from an aluminium alloy strip, or alternatively by extrusion moulding from an aluminium slug. Further material connections may be achieved by soldering or welding between the housing shell and the lid, in which case the lid may optionally be formed as a separate part and further optionally from another material, for example another aluminium alloy or another metal. Force-fit connections between the housing shell and the lid may also be achieved by crimping the lid to the housing shell. Finally, the battery cell housing may be closed with a further lid consisting of an aluminium alloy or another material after the jelly roll has been arranged in the cup-shaped housing shell. Here as well, the force-fit and/or material connection may be provided between the second lid and the housing shell.

According to a further aspect, the stated object is also achieved for the use of an aluminium alloy for manufacturing a battery cell housing according to the invention in that an aluminium alloy strip or sheet of the aluminium alloy is deep drawn/or stretch drawn to form a tube or cup. Deep drawing and/or stretch drawing are economical processes for manufacturing highly precise tubes or cups from an aluminium alloy strip or sheet. This use of an aluminium alloy is therefore particularly suitable for providing battery cell housings according to the invention as mass-produced articles.

According to one advantageous embodiment of the use, the aluminium alloy strip or sheet has the state H18, H19 before the deep drawing and/or stretch drawing. in this way, the highest values of the yield strength R_{p0.2} may also be achieved after stretch drawing and/or deep drawing the tube or cup, and battery cell housings according to the invention may also be manufactured from not hardenable or naturally hard aluminium alloys. In this respect, battery cell housings comprising a not hardenable or naturally hard aluminium alloy according to the invention with values of the yield strength R_{p0.2} of at least 183 MPa consisting of a conventional aluminium alloy may be provided even for large cell diameters.

If the aluminium alloy strip or sheet, according to one configuration of the use of an aluminium alloy strip, consists of a hardenable aluminium alloy and the aluminium alloy strip has the state T4 before the deep drawing and/or stretch drawing, then the deep drawing and/or stretch drawing may be facilitated and greater degrees of deformation may be produced. The high values of the yield strength of the battery cell housing according to the invention are then achieved by hardening to the state T6 or T6x, for example by tempering for 30 minutes at 205° C. In order to optimise the electrical and thermal conductivities, deliberate further ageing to the state T7 or T7x may also be envisaged and may provide a sufficiently high yield strength R_{p0.2} of at least 183 MPa.

According to an alternative use of the aluminium alloy strip or sheet, the housing shell of the battery cell housing is manufactured by longitudinally seam welding a tube of an aluminium alloy strip or sheet. Preferably, the tube is rolled from an aluminium alloy strip having the composition according to the invention. Here as well, a particularly economical use of an aluminium strip or sheet may be provided in order to manufacture a battery cell housing according to the invention.

Finally, according to an alternative use of an aluminium alloy, the housing shell is extrusion moulded optionally together with a lid region from an aluminium alloy slug. Alternatively, the housing shell of the battery cell housing may also be manufactured by extruding a tube with subsequent optional stretch drawing of the tube. Both methods represent uses of aluminium alloys that allow very economical production of highly precise battery cell housings from an aluminium alloy with advantageous properties in terms of thermal conductivity and weight.

### BRIEF DESCRIPTION OF THE DRAWINGS

The invention will be explained in more detail below in relation to the drawing and the exemplary embodiments. In the drawing:

FIG. 1 is a schematic view of two different uses of an aluminium alloy for manufacturing a battery cell housing of a round battery cell, and;

FIG. 2 is a schematic view of a further use of an aluminium alloy for manufacturing a battery housing of a round battery cell.

### DETAILED DESCRIPTION OF THE INVENTION

The basis of the studies is the known use of a steel of the type AISI 1020 to manufacture a battery cell housing for a battery cell. Large-format round cells of the type 4680, for example, increase the requirements for dissipation of heat from the interior of the round battery cell, since the geometrical possibilities for round battery cells are limited. Larger cell heights and, in particular, cell diameters lead to a reduction of the surface area to volume ratio, which may greatly impair the dissipation of heat. However, the use of aluminium alloys offers significantly better electrical and thermal conductivities than steel, so that the resulting heat of reaction and ohmic heating can be dissipated more efficiently through the housing and a performance gain may therefore be expected, specifically by better thermal management. Furthermore, the good electrical conductivity of aluminium reduces the development of heat by reducing the ohmic resistance of the cell, since the housing in cylindrical cells carries current and constitutes one pole of the cell.

Contrasting therewith are the higher mechanical requirements for the battery cell housing of round battery cells with diameters of more than 15 mm, in particular more than 20 mm or more than 22 mm. In order to ensure these, a higher wall thickness of the battery cell housing, in particular of the housing shell, must be tolerated. However, a higher wall thickness reduces the space for the “jelly roll”, so that the winding length is shortened and the electrode area is reduced. A loss or gain in the energy capacity of the battery cell housing may therefore be estimated from the winding length ratio.

The wall thickness of the housing shell may be designed using the Barlow's formula known from elastostatics

$${σ}_{φ} = p \cdot {R}_{i} / s \qquad ( 1 )$$

with σ_{φ}: stress component in the circumferential direction, p: internal pressure, Rᵢ: inner radius, s: wall thicknesses
using the reference stress according to Tresca

$${σ}_{V , Tresca} = {σ}_{max} - {σ}_{min} = {σ}_{φ} - 0 = p \cdot {R}_{i} / s \qquad ( 2 )$$

with the condition

$${σ}_{V , Tresca} \leq {R}_{p 0.2} \qquad ( 3 )$$

Furthermore, assuming the same maximum internal pressure,

$$p = {R}_{p 0.2 , Al} \cdot {s}_{Al} / {R}_{i , Al} = {R}_{p 0.2 , St} \cdot {s}_{St} / {R}_{i , St} \qquad ( 4 )$$

and assuming the same internal Rᵢ radius of the cells, gives

$${R}_{p 0.2 , Al} \cdot {s}_{Al} = {R}_{p 0.2 , St} \cdot {s}_{St} , \qquad ( 5 )$$

so that the wall thickness ratio δ may be calculated from the aforementioned yield strength ratio as:

$$δ = {s}_{Al} / {s}_{St} = {R}_{p 0.2 , St} / {R}_{p 0.2 , Al} \qquad ( 7 )$$

The wall thickness ratio δ with respect to steel is a measure of the increase in the wall thickness of the battery cell housing when replacing steel with aluminium, and may in particular be used to compare different aluminium alloy strips or sheets with one another.

For a given internal pressure, a minimum wall thickness with which the aforementioned conditions are satisfied may be determined for a battery cell housing of a round battery cell consisting of steel of the type AISI 1020. Since cylindrical secondary batteries, in particular lithium ion batteries, are usually equipped with pressure relief mechanisms that are activated at for instance 2 MPa, an internal pressure p=9 MPa was calculated in the present case, taking into account a safety factor of 4.5, in order to reliably rule out lateral tearing of the battery in conjunction with current interruption and pressure relief mechanisms to be provided. This represents a typical value of required internal pressure stability. Using this minimum wall thickness of the housing shell, with the assumption of a constant size of the winding core and a defined thickness of a layer of the “jelly roll” of the battery consisting of separators, active materials and current collector film, the winding length W of the “jelly roll” may be calculated as follows:

$$A = {d}_{jelly roll} \cdot W = \frac{π}{4} \cdot {( {D}_{battery} - 2 \cdot {d}_{shell} )}^{2} - {D}_{inner}^{2} ) \qquad ( 8 )$$

with
A: area of the winding level,
d_{jelly roll}: thickness of the film stack wrapped to the jelly roll,
W: winding length
D_{battery}: outer diameter of the battery cell housing,
dₛₕₑₗₗ: thickness or wall thickness of the housing shell
Dᵢₙₙₑᵣ: inner diameter of the winding level

The jelly roll film stack consists of separator films, cathode current collector film, which is coated with the cathode active material, and anode current collector film, which is coated with the anode active material.

From the possible winding length of the jelly roll, depending on the wall thickness of the battery cell housing, for a given outer diameter, the capacity loss in battery cell housings with a housing shell that consists at least partially of an aluminium alloy may be estimated for different values of the yield strength R_{p0.2} of the housing shell by means of the winding length ratio.

The winding length ratio

$$\frac{{W}_{Al}}{{W}_{steel}}$$

may for this purpose be calculated as follows:

$$\frac{{w}_{Al}}{{w}_{steel}} = \frac{( {( {D}_{battery} - 2 {d}_{Al} )}^{2} - {D}_{inner}^{2} )}{( {( {D}_{battery} - 2 {d}_{St} )}^{2} - {D}_{inner}^{2} )} \qquad ( 9 )$$

with
d_{Al}: thickness of the housing shell when using the respective aluminium material
d_{Steel}: thickness of the housing shell when accepting a steel with R_{p02.St}=350 MPa.

It was found that in the case of round cells of the type 4680 with an outer diameter of 46 mm of the battery cell housing and a housing shell consisting of an aluminium alloy, the yield strength R_{p0.2} of the housing shell must be at least 183 MPa, preferably at least 220 MPa, particularly preferably at least 250 MPa, in order to keep possible capacity losses below 5%. The battery cell housing according to the invention may therefore provide advantages in terms of improved thermal management and reduced weight with acceptable capacity losses, especially in large-format round battery cells with diameters of more than 15 mm, preferably more than 20 mm or more than 22 mm.

Various aluminium alloys from different production processes were then studied with regard to their suitability for providing a battery cell housing. These are listed in Table 1. Exemplary embodiments according to the invention are denoted by E and comparative examples not according to the invention are denoted by V.

TABLE 1

| No | Type | Si | Fe | Cu | Mn | Mg | Cr | Zn | Ti | V | Zr | Ni |
|---|---|---|---|---|---|---|---|---|---|---|---|---|
| 1 | V | 0.08 | 0.23 | 0.01 | <0.01 | 0.01 | <0.01 | 0.02 | 0.01 | 0.01 | <0.01 | <0.01 |
| 2 | E | 0.25 | 0.59 | 0.18 | 0.84 | 1.03 | 0.01 | 0.04 | 0.02 | 0.01 | <0.01 | <0.01 |
| 3 | E | 0.23 | 0.59 | 0.18 | 0.82 | 1.03 | 0.01 | 0.04 | 0.03 | 0.01 | <0.01 | <0.01 |
| 4 | V | 0.20 | 0.53 | 0.14 | 1.05 | <0.01 | <0.01 | <0.01 | 0.02 | <0.01 | <0.01 | <0.01 |
| 5 | E | 0.5 | 0.15 | <0.01 | <0.01 | 0.47 | <0.01 | <0.01 | 0.01 | 0.01 | <0.01 | <0.01 |
| 6 | E | 0.44 | 0.11 | 0.24 | <0.01 | 0.44 | <0.01 | <0.01 | <0.01 | <0.01 | <0.01 | <0.01 |
| 7 | E | 0.47 | 0.12 | <0.01 | <0.01 | 0.46 | <0.01 | <0.01 | <0.01 | <0.01 | 0.18 | <0.01 |
| 8 | E | 0.47 | 0.12 | 0.25 | <0.01 | 0.40 | <0.01 | <0.01 | <0.01 | <0.01 | 0.07 | <0.01 |
| 9 | E | 0.50 | 0.12 | <0.01 | <0.01 | 0.47 | <0.01 | <0.01 | <0.01 | <0.01 | <0.01 | 0.19 |
| 10 | E | 0.88 | 0.33 | 0.10 | 0.54 | 0.87 | 0.01 | 0.02 | 0.03 | <0.01 | <0.01 | <0.01 |
| 11 | E | 0.72 | 0.21 | 0.10 | 0.07 | 0.59 | <0.01 | <0.01 | 0.02 | <0.01 | <0.01 | <0.01 |
| 12 | E | 1.1 | 0.25 | 0.045 | 0.07 | 0.42 | <0.01 | 0.01 | 0.02 | 0.02 | <0.01 | <0.01 |
| 13 | E | 0.25 | 0.50 | 0.16 | 1.08 | 0.02 | 0.04 | <0.01 | 0.02 | <0.01 | <0.01 | <0.01 |
| 14 | E | 0.6 | 0.28 | 0.44 | 1.36 | 0.25 | 0.11 | <0.01 | 0.02 | <0.01 | <0.01 | <0.01 |

*All data in wt %, the remainder being Al and unavoidable impurities, individually at most 0.03 wt % and in total at most 0.1 wt %

Table 2 provides information about the manufacturing method for the various exemplary embodiments. In order to facilitate sampling for tensile tests in comparison with extruded tube samples, the exemplary embodiments studied sometimes have final thicknesses that are not suitable for battery cell housings, e.g. examples 6 to 10. It is expected that the wall thicknesses of the housing shell of a battery cell housing of a round battery cell with diameters of more than 15 mm, more than 20 mm, preferably more than 22 mm, will preferably be between 0.5 mm and 2.5 mm, preferably up to 1.5 mm, preferably from 0.7 mm to 1.2 mm. In principle, wall thicknesses above 2.5 mm and below 0.5 mm may also be envisaged depending on the cell diameter, which according to (1) is proportional to the stress component in the circumferential direction.

However, it is assumed that despite the sometimes large differences from the wall thickness required on the battery cell housing (e.g. examples 6 to 10), the measured values of the yield strength R_{p0.2} may also readily be achieved in the aforementioned thickness range by adjustment of the processing, in particular the solution annealing and the artificial ageing of the aluminium alloy to the final thickness to be achieved. Since the yield strength values R_{p0.2} are independent of thickness and are determined by the composition and microstructure of the material, including the temper state, the results determined here may also be applied to the required wall thicknesses. All characteristic mechanical values for R_{p0.2} and Rₘ refer to values according to DIN EN 6892.

TABLE 2

| | | Final | | Hot strip | | Final | |
|---|---|---|---|---|---|---|---|
| | | thickness | | thickness | Intermediate | rolling | Final |
| No | Ty | [mm] | State | [mm] | annealing | ratio | annealing |
| 1 | V | 0.8 | H14 | 2.3 | — | 59% | — |
| 2 | E | 0.95 | H24 | 2.3 | — | 59% | coil |
| | | | | | | | annealing |
| | | | | | | | 250° C. |
| 3 | E | 0.5 | H19 | 2.3 | — | 78% | — |
| 4 | V | 1.0 | H14 | 7 | coil annealing | 28% | — |
| | | | | | 400° C. at | | |
| | | | | | 1.39 mm | | |
| 5 | E | 0.5 | H19 | | — | 90% | |
| 6 | E | 10 | extruded T6 | | solution | | ageing |
| | | | | | annealing at | | 16 h @ |
| | | | | | 10 mm | | 165° C. |
| 7 | E | 10 | extruded T6 | | solution | | ageing |
| | | | | | annealing at | | 16 h @ |
| | | | | | 10 mm | | 165° C. |
| 8 | E | 10 | extruded T6 | | solution | | ageing |
| | | | | | annealing at | | 16 h @ |
| | | | | | 10 mm | | 165° C. |
| 9 | E | 10 | extruded T6 | | solution | | ageing |
| | | | | | annealing at | | 16 h @ |
| | | | | | 10 mm | | 165° C. |
| 10 | E | 2.5 | T6 | | solution | | coil |
| | | | | | annealing at | | annealing |
| | | | | | 2.5 mm | | 180° C. |
| 11 | E | 1.0 | T6 | | solution | | ageing |
| | | | | | annealing at | | 30 min @ |
| | | | | | 1.0 mm | | 205° C. |
| 12 | E | 1.0 | T64 | | solution | | ageing 2% |
| | | | | | annealing at | | stretching + |
| | | | | | 1.0 mm | | 20 185° C. |
| 13 | E | 1.1 | H19 | 7 | | 84% | |
| 14 | E | 1.5 | H24 | 7 | | 79% | coil annealing |
| | | | | | | | 250° C. |

In Table 2, examples 1 to 4 and 10 to 14 were hot and cold rolled from a DC rolling ingot casting with homogenisation under conventional conditions at final thickness. The homogenisation was carried out at a temperature between 480° C. and 620° C. for a period of at least 0.5 h. The hot rolling of the rolling ingot to form a hot-rolled strip took place at a temperature between 280° C. and 550° C., the hot strip temperature after the last hot rolling pass being between 280° C. and 380° C. The hot strip thickness, i.e. the thickness of the hot-rolled strip, was between 2 mm and 10 mm. The cold rolling of the aluminium alloy strip or sheet may be carried out in one or more passes.

Example 5 was produced by double roll casting followed by cold rolling with intermediate annealing at 165° C. after the first rolling pass of 15%. Examples 2, 3, 13 and 14 represent exemplary embodiments according to the invention for not hardenable or naturally hard aluminium alloys for the battery cell housing, in particular the housing shell. Comparative examples 1 and 4 not according to the invention likewise consist of not hardenable or naturally hard aluminium alloys.

Exemplary embodiments 6 to 12 according to the invention comprise hardenable AlMgSi alloys. After the hot and cold rolling to final thickness or extrusion to final geometry, they were brought to the state T4 by solution annealing and quenching. Heat treatment was then carried out in the form of annealing, or artificial ageing, in order to convert the exemplary embodiments to the state T6 or to the state T6x, here to the state T64 by additional stretching by 2%. It is also conceivable here to convert the state to T7 or T7x. The achievable yield strength values R_{p0.2} were measured on the examples consisting of different aluminium alloys and manufactured with different process steps, and were used to calculate a wall thickness or to calculate a winding length ratio in comparison with the battery cell housing consisting of AISI 1020 steel.

Further, the electrical conductivity in MS/m and (% IACS) was determined for the various materials by means of eddy current testing according to DIN EN 2004-1 1993-09. The thermal conductivity λ may be calculated with the aid of the electrical conductivity σ while taking into account the Wiedemann-Franz law,

$$λ = L \cdot σ \cdot T \qquad ( 10 )$$

$$with$$

$$L = 2. \cdot {10}^{- 8} W Ω {K}^{- 2}$$

(Lorentz number for aluminium at room temperature: source: Aluminium Handbook Volume 1, 16^{th} edition, Aluminium Verlag)
σ: electrical conductivity,
T: temperature (room temperature assumed to be 25° C.)

For the reference material AISI 1020 steel, the thermal conductivity is about 67 W/mK at room temperature. The results of the calculations are presented in Table 3. All aluminium alloys are expected to be well above the reference value for steel of the type AISI 1020 in terms of electrical and thermal conductivities. Comparative example 1, on the other hand, shows an insufficient yield strength of 100 MPa, resulting in an outer diameter/wall thickness ratio of 23.71 at an assumed internal pressure of 9 MPa to be produced. The necessary wall thickness resulting therefrom for battery cell housings, for example for type 4680 with an outer diameter of 46 mm, leads to significant capacity losses in relation to the achievable winding length of the jelly roll, so that the advantages of excellent electrical and thermal conductivities cannot be exploited. On the other hand, exemplary embodiments 2 and 3 according to the invention show significantly lower losses with respect to the winding length. Exemplary embodiments 2 and 3 still have acceptable electrical and thermal conductivities. Due to the large difference in these parameters from the material AISI 1020 steel, suitability for large-format battery cell housings may nevertheless be assumed.

Comparative example 4, which represents the material AA3003 H14 often used for prismatic battery boxes, also has an insufficient yield strength R_{p0.2} and leads to a significant loss of winding length, when taking into account the necessary wall thickness, so that the comparative example in the state H14 is not suitable for a battery cell housing according to the invention. Exemplary embodiment 13 has an almost identical aluminium alloy to comparative example 4 because of the different material state H19. Owing to the good processing properties of this aluminium alloy, however, battery cell housings may also be manufactured with low winding length losses.

Exemplary embodiments 5 to 9 according to the invention show consistently high strengths, exemplary embodiment 5 in the state H19 having been manufactured by double roll casting with subsequent cold rolling with intermediate annealing at 165° C. after the first rolling pass of 15%, and exemplary embodiments 6 to 9 having been manufactured by extrusion. The extruded variants were measured in the state T6. The strength-increasing properties of copper in comparison with additions of zirconium may clearly be recognised from a comparison of exemplary embodiments 6 and 7. Nickel, as shown in exemplary embodiment 9, also leads to an increase in the yield strengths R_{p0.2}.

The highest yield strength values were obtained in exemplary embodiment 10 manufactured using the DC ingot casting route with hot and cold rolling as well as solution annealing in a continuous furnace. Here, the conversion to the state T6 was carried out by means of coil annealing for 4 h at 180° C. The lowest winding length losses of less than 1.5% were achieved with an aluminium alloy strip according to exemplary embodiment 10. The less strong variants of the aluminium alloy of exemplary embodiments 11 and 12 complete the group of aluminium alloys AlMgSi, exemplary embodiments 5 to 12, and show that these aluminium alloys are also suitable for manufacturing battery cell housings according to the invention.

Because of the different processing properties of the aluminium alloys, there are various possible uses of the aluminium alloys for manufacturing the battery cell housings, which will be explained in more detail below with the aid of the drawing.

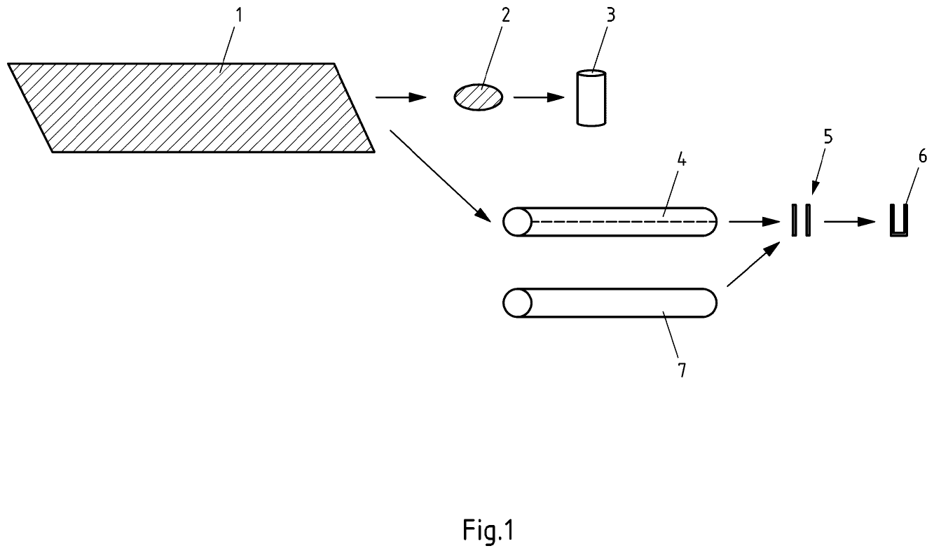

FIG. 1 now shows 3 different uses of aluminium alloys for manufacturing battery cell housings. First, an aluminium alloy strip 1 is shown, which may be manufactured by casting a rolling ingot, for example according to the DC casting method, or alternatively according to a casting rolling method with subsequent hot and/or cold rolling. Segments 2 produced from the strip 1 are drawn in deep drawing and/or stretch drawing tools (not represented) to form tubes, but above all to form cylindrical cups 3, into which the “jelly roll” (not represented) may be inserted.

According to a further use that is represented, the aluminium alloy strip is for example formed into a longitudinally seam welded tube 4 by roll forming and subsequent welding. The housing shell of the battery cell housing may then be separated therefrom as a tube portion 5. The tube portion 5 may subsequently also be provided with a lid 6 in order to be able to contain a “jelly roll”. The lid 6 is connected to the tube or tube portion 5 by means of a material or force-fit connection, for example by soldering, welding or crimping.

As a third use, an extruded tube 7 is manufactured. This is usually stretch drawn to size. Tube portions 5 may subsequently likewise be provided with a lid 6.

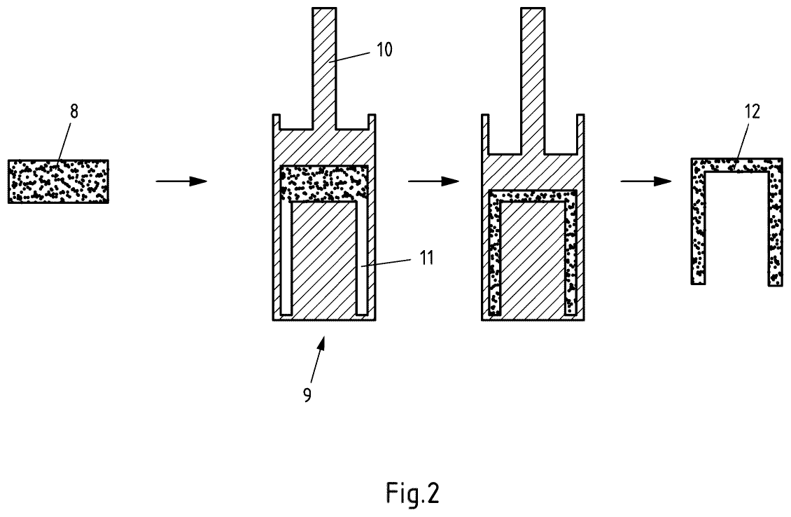

Finally, FIG. 2 schematically the use of an aluminium alloy for manufacturing a battery cell housing by extrusion moulding an aluminium alloy slug 8 in an extrusion moulding press 9 with a punch 10 and a die 11. The finished housing shell 12 with a lid is highly precise and may likewise be manufactured as mass-produced goods. Nevertheless, a tube portion may also readily be produced, i.e. without a lid, by extrusion moulding. The processing of tube portions 5 to form battery cell housings of round cells is described with reference to FIG. 1.

TABLE 3

| | | | | | | | Calculated wall | | Outer diameter/wall | Winding |
|---|---|---|---|---|---|---|---|---|---|---|
| | | | | | Calculated | Wall | thickness for 4680 | | thickness (4680 | length ratio in |
| | | | | Electrical | thermal | thickness | geometry with 9 | Resulting | format and 9 | comparison |
| | | | | conductivity | conductivity | ratio | MPa internal | inner | MPa internal | with steel (46 |
| | | Rₚ₀₂ | Rₘ | [MS/mm] | [W/mK] | to steel | pressure | diameter | pressure with | mm diameter, |
| No | Type | [MPa] | [MPa] | (% IACS) | (25° C.) | (AISI 1020) | (σₒ = Rₚ₀₂ − 2 MPa) | (mm) | (σₒ = Rₚ₀₂ − 2 MPa) | 4 mm coil) |
| 1 | V | 100 | 105 | 36.7 | 219 | 3.5 | 1.94 | 42.120 | 23.71 | 0.881 |
| | | | | (63.2) | | | | | | |
| 2 | E | 190 | 225 | 24.2 | 144 | 1.84 | 1.050 | 43.900 | 43.81 | 0.958 |
| | | | | (41.7) | | | | | | |
| 3 | E | 274 | 302 | 22.4 | 134 | 1.287 | 0.736 | 44.528 | 62.50 | 0.986 |
| | | | | (38.6) | | | | | | |
| 4 | V | 157 | 168 | 28.5 | 170 | 2.22 | 1.265 | 43.470 | 36.36 | 0.939 |
| | | | | (49.1) | | | | | | |
| 5 | E | 258 | 268 | 32.4 | 193 | 1.365 | 0.780 | 44.440 | 58.97 | 0.982 |
| | | | | (55.9) | | | | | | |
| 6 | E | 251 | 278 | 32.3 | 193 | 1.39 | 0.802 | 44.396 | 57.36 | 0.980 |
| | | | | (55.7) | | | | | | |
| 7 | E | 228 | 245 | 31.5 | 188 | 1.543 | 0.879 | 44.242 | 52.33 | 0.973 |
| | | | | (54.3) | | | | | | |
| 8 | E | 246 | 276 | 31.3 | 187 | 1.42 | 0.818 | 44.364 | 56.23 | 0.978 |
| | | | | (53.9) | | | | | | |
| 9 | E | 249 | 277 | 32.2 | 192 | 1.41 | 0.810 | 44.380 | 56.79 | 0.979 |
| | | | | (55.5) | | | | | | |
| 10 | E | 287 | 345 | 26.8 | 160 | 1.22 | 0.704 | 44.592 | 65.34 | 0.989 |
| | | | | (46.2) | | | | | | |
| 11 | E | 201 | 249 | 28.7 | 171 | 1.74 | 0.993 | 44.014 | 46.32 | 0.963 |
| | | | | (49.5) | | | | | | |
| 12 | E | 183 | 256 | 26.7 | 159 | 1.91 | 1.090 | 43.820 | 42.20 | 0.955 |
| | | | | (46.0) | | | | | | |
| 13 | E | 218 | 238 | 26.2 | 156 | 1.61 | 0.922 | 44.156 | 49.89 | 0.969 |
| | | | | (45.2) | | | | | | |
| 14 | E | 226 | 256 | 30.2 | 177 | 1.55 | 0.888 | 44.224 | 51.80 | 0.973 |
| | | | | (52.1) | | | | | | |

*Reference value AISI 1020 steel: R_{p0.2} = 350 MPa, reference wall thickness of battery cell housing 4680 geometry: 0.58 mm

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A battery cell housing of a round battery cell, comprising a cylindrical housing shell with an outer diameter of more than 15 mm, preferably more than 20 mm, particularly preferably more than 22 mm, wherein the housing shell consists at least partially of an aluminium alloy wherein the aluminium alloy of the housing shell has the following composition in wt %:
0.2%≤Si≤2.0%,
Fe≤0.5%,
Cu≤0.8%,
Mn≤1.4%,
Mg≤2.0%,
Cr≤0.25%,
Zn≤0.4%,
Ti≤0.2%,
V≤0.05%,
Zr≤0.25%,
Ni≤0.2%,
the remainder being Al with unavoidable impurities, individually at most 0.05% and in total at most 0.15%, and the yield strength R_{p0.2} of the housing shell is at least 183 MPa, preferably at least 220 MPa, particularly preferably at least 250 MPa.

2. The battery cell housing according to claim 1, wherein the housing shell of the battery cell housing has a wall thickness which satisfies the following relationship: outer diameter/wall thickness >41.5, preferably >47.5, particularly preferably >55.0.

3. The battery cell housing according to claim 1, wherein the housing shell has an electrical conductivity of more than 25 MS/m, preferably more than 28 MS/m, particularly preferably more than 30 MS/m.

4. The battery cell housing according to claim 1, wherein the aluminium alloy of the housing shell has the following composition in wt %:
0.2%≤Si≤1.5%, preferably 0.3%≤Si≤1.3%,
Fe≤0.5%,
Cu≤0.6%, preferably ≤0.45%,
Mn≤1.4%, preferably 1.0%≤Mn≤1.4%, more preferably Mn≤0.6%,
Mg≤1.5%, preferably 0.2%≤Mg≤1.5%,
Cr≤0.25%, preferably ≤0.15%,
Zn≤0.25%,
0.01%≤Ti≤0.20%,
V≤0.05%, preferably ≤0.03%,
Zr≤0.20%, preferably ≤0.05%,
Ni≤0.05%, preferably ≤0.03%,
the remainder being Al with unavoidable impurities, individually at most 0.05%, preferably 0.03%, and in total at most 0.15%, preferably at most 0.10%.

5. The battery cell housing according to claim 1, wherein the aluminium alloy of the housing shell is hardenable and has the following composition in wt %:
0.3%≤Si≤0.7%,
Fe≤0.5%,
Cu≤0.45%,
Mn≤0.05%,
0.22%≤Mg≤0.8%,
Cr≤0.03%,
Zn≤0.1%,
0.01%≤Ti≤0.20%,
V≤0.03%, preferably ≤0.015%,
Zr≤0.05%, preferably ≤0.015%,
Ni≤0.03%, preferably ≤0.015%,
the remainder being Al with unavoidable impurities, individually at most 0.03% and in total at most 0.10%.

6. The battery cell housing according to claim 1, wherein the aluminium alloy of the housing shell is not hardenable and has the following composition in wt %:
0.2%≤Si≤0.6%,
Fe≤0.5%,
Cu≤0.45%,
1.0%≤Mn≤1.4%,
Mg≤1.10%, preferably ≤0.8%,
Cr≤0.25%,
Zn≤0.4%,
Ti≤0.2%, preferably 0.01%≤Ti≤0.20%,
V≤0.05%,
Zr≤0.25%,
Ni≤0.2%,
the remainder being Al with unavoidable impurities, individually at most 0.05% and in total at most 0.15%.

7. The battery cell housing according to claim 1, wherein the housing shell consists of a hardenable alloy and has the temper state T6, T6x, T7 or T7x.

8. The battery cell housing according to claim 1, wherein the housing shell has at least one lid, which is connected thereto materially or by a force-fit.

9. Use of an aluminium alloy for manufacturing a battery cell housing according claim 1, wherein an aluminium alloy strip or sheet of the aluminium alloy is deep drawn/or stretch drawn to form a tube or cup.

10. Use according to claim 9, wherein the aluminium alloy strip or sheet is in the state H18, H19 before the deep drawing and/or stretch drawing.

11. Use according to claim 9, wherein the aluminium alloy strip or sheet consists of a hardenable aluminium alloy and has the state T4 before the deep drawing and/or stretch drawing.

12. Use according to claim 9, wherein the housing shell of the battery cell housing is alternatively manufactured by longitudinal seam welding an optional rolled tube of an aluminium alloy strip or sheet.

13. Use according to claim 9, wherein the housing shell is alternatively extrusion moulded optionally with a lid region from an aluminium alloy slug or the housing shell is stretch drawn from an extruded tube.
